(19) United States
(12) Patent Application Publication
(10) Pub. No.: US 2024/0139847 A1
(43) Pub. Date: May 2, 2024

(54) BRAZING JOINT, BRAZING METHOD AND DEVICE, FOR PROMOTING SOLDER RHEOLOGY AND GAS OVERFLOW

(71) Applicants: CHINA ACADEMY OF MACHINERY NINGBO ACADEMY OF INTELLIGENT MACHINE TOOL CO., LTD., Ningbo (CN); ZHENGZHOU RESEARCH INSTITUTE OF MECHANICAL ENGINEERING CO., LTD., Zhengzhou (CN)

(72) Inventors: Weimin LONG; Xiaoguo SONG; Sujuan ZHONG; Lianhui JIA; Limei JIN; Yucan FU; Yongqiang WEI; Yuchang WANG; Guoqin HUANG; Lei ZHANG; Long FU

(73) Assignees: CHINA ACADEMY OF MACHINERY NINGBO ACADEMY OF INTELLIGENT MACHINE TOOL CO., LTD., Ningbo, ZJ (CN); ZHENGZHOU RESEARCH INSTITUTE OF MECHANICAL ENGINEERING CO., LTD., Zhengzhou, YU (CN)

(21) Appl. No.: 18/250,590

(22) PCT Filed: Dec. 9, 2022
(86) PCT No.: PCT/CN2022/123929

§ 371 Date: Jan. 18, 2024

(30) Foreign Application Priority Data
Jul. 13, 2022 (CN) 202210818561.7

(51) Int. Cl. B23K 1/06; B23K 1/002; B23K 35/30

(52) U.S. Cl. CPC B23K 1/06; B23K 1/002; B23K 35/3006

(57) ABSTRACT

A brazing joint, a brazing method, and a device for promoting solder rheology and gas overflow are provided. The brazing joint includes a first base metal, a second base metal, and a brazing seam located therebetween. The brazing seam is formed by filling a solder in a gap formed by welding surfaces of the first and the second base metal and melting it to connect the first and the second base metal. The brazing seam is a concave-shaped brazing seam. The gap defines a first distance and a second distance, the first distance is located at an edge of the gap, the second distance is located at the edge or an inside of the gap, the first distance is greater than the second distance, and a curved surface is formed between the location of the first distance and the location of the second distance for transition.

### CROSS-REFERENCE TO RELEVANT APPLICATIONS

The present application claims the priority of the Chinese patent application filed on Jul. 13, 2022 before the CNIPA, China National Intellectual Property Administration with the application number 202210818561.7 and the title of “BRAZING JOINT, BRAZING METHOD AND DEVICE, FOR SOLDER RHEOLOGY AND GAS OVERFLOW”, which is incorporated herein in its entirety by reference.

### TECHNICAL FIELD

The present application relates to the technical field of brazing, and more particularly, to a brazing joint, a brazing method and a device, for promoting solder rheology and gas overflow.

### BACKGROUND ART

Brazing refers to a welding method in which liquid solder is used to fill a gap in a solid workpiece to connect metals, after the solder whose melting point is lower than the melting point of a weldment and the weldment are both heated to the melting temperature of the solder at the same time. During brazing, oxide films and oil stains on the contact surfaces of base metals (base materials) are required to be removed first, so that capillaries are able to play a role to improve the wettability and capillary fluidity of the solder, after the solder is melted. Brazing is further divided into hard soldering and soft soldering according to the different melting points of solders.

During the brazing process, the slag discharge effect and the gas overflow effect are not ideal, which causes the deterioration of the quality of the brazing joint. Therefore, it is urgent to propose a brazing joint, a brazing method and a device, with a good slag discharge effect and gas overflow effect.

### SUMMARY

The object of the present application is to solve the above-mentioned problems in the prior art and to propose a brazing joint, a brazing method, and a device for promoting solder rheology and gas overflow.

The object of the present application may be achieved by the following technical solutions: a brazing joint for promoting solder rheology and gas overflow.

In the above-mentioned brazing joint for promoting solder rheology and gas overflow, it includes: a first base metal, a second base metal, and a brazing seam located between the first base metal and the second base metal, wherein the brazing seam is formed by filling a solder into a gap formed by a welding surface of the first base metal and a welding surface of the second base metal and melting it to connect the first base metal and the second base metal, wherein the brazing seam is a concave-shaped brazing seam; the gap defines a first distance and a second distance, the first distance is located at an edge of the gap, the second distance is located at the edge or inside of the gap, the first distance is greater than the second distance, and a curved surface is formed between the location of the first distance and the location of the second distance for transition.

In the above-mentioned brazing joint for promoting solder rheology and gas overflow, the curved surface is provided on the first base metal and/or the second base metal.

In the above-mentioned brazing joint for promoting solder rheology and gas overflow, the first base metal includes a first welding surface, and the second base metal includes a second welding surface, wherein the first welding surface and/or the second welding surface are provided with strip-shaped textures, and the strip-shaped textures extend from the location of the first distance to the location of the second distance.

In the above-mentioned brazing joint for promoting solder rheology and gas overflow, a material of the first base metal is copper, steel, or cemented carbide (hard alloy); and a material of the second base metal is copper, steel, or cemented carbide.

In the above-mentioned brazing joint for promoting solder rheology and gas overflow, the solder is copper-based solder, or silver-based solder.

In the above-mentioned brazing joint for promoting solder rheology and gas overflow, the solder contains 0.2%-1.5% silicon, or 0.5%-3.5% tin, which controls the solder to form the concave-shaped brazing seam along the gap during a brazing process.

The present application further provides a brazing method for promoting solder rheology and gas overflow, which is used for welding the brazing joint for promoting solder rheology and gas overflow as mentioned above, wherein the welding surface of the first base metal, and the welding surface of the second base metal are coated with brazing flux, the first base metal, the solder, and the second base metal are assembled into a to-be-welded brazing joint, and the to-be-welded brazing joint is heated to complete the brazing, to obtain the brazing joint.

In the above-mentioned brazing method for promoting solder rheology and gas overflow, a vibration is applied to the brazing joint during the brazing process, and the vibration has phase-shifted longitudinal waves and transverse waves, to accelerate the flowing of the solder in the gap.

In the above-mentioned brazing method for promoting solder rheology and gas overflow, a magnetic field is applied to the brazing joint during the brazing process, to accelerate the flowing of the solder in the gap.

The present application further provides a device for promoting solder rheology and gas overflow, based on the brazing method for promoting solder rheology and gas overflow as mentioned above, including a vibration unit and/or a magnetic field generator.

Compared with the prior art, the present application has the following beneficial effects.

For the brazing joint for promoting solder rheology and gas overflow provided by the present application, a first distance and a second distance which are not equal are defined in a gap between a first base metal and a second base metal, and the first distance located at an edge of the first base metal and/or the second base metal is greater than the second distance, and a curved surface is formed between the location of the first distance and the location of the second distance for transition, such that the distance from the inside of the gap to the edge of the gap increases gradually, that is, the first distance is ensured to be greater than the second distance, so that bubbles and slags may be discharged from the location of the second distance to the location of the first distance, until they are discharged out of the brazing seam. In addition, the setting of the concave-shaped brazing seam further promotes the discharge of bubbles and slags, which greatly improves the efficiency of the slag discharge during the brazing process, and effectively improves the quality of the joint to ensure the product welding quality. By providing strip-shaped textures on the first base metal and/or the second base metal, and making the strip-shaped textures extend from the location of the first distance to the location of the second distance, the flowing of the solder is promoted during the brazing process, to enable the solder under the molten state to flow in the direction of the strip-shaped textures, to ensure the welding quality. The strip-shaped textures are processed by knurling, the processing technology is simple and the production cost is low. By providing an ultrasonic vibration unit in a brazing device, the ultrasonic vibration unit generates longitudinal waves and transverse waves during the welding process, which further promotes the flowing of the solder during the welding process, to enable the solder under the molten state to flow quickly in the gap between the first base metal and the second base metal, which can promote, while promoting the flowing of solder, the flowing of bubbles, accelerate the discharge of bubbles and slags, and greatly improve the welding quality. By providing a magnetic field generator in the brazing device, the magnetic field generated by the magnetic field generator promotes the rheology of liquid solder in the fluctuation, which greatly accelerates the flow speed of the solder and improves the welding efficiency. By adding silicon or tin to the solder to regulate the surface tension of the solder, a concave-shaped surface is formed at the end of the brazing seam, to enable a smooth transition at the interface between the brazing seam and the base metals, which facilitates the discharge of bubbles and slags and improves the welding quality.

### BRIEF DESCRIPTION OF THE DRAWINGS

FIG. 1 shows a schematic structure diagram of base metals of the present application;

FIG. 2 shows a schematic diagram of a brazing joint of the present application;

FIG. 3 shows a schematic diagram of configuration of a first brazing seam between materials of the present application;

FIG. 4 shows a schematic diagram of configuration of a second brazing seam between base metals of the present application;

FIG. 5 shows a schematic diagram of configuration of a third brazing seam between base metals of the present application;

FIG. 6 shows a schematic diagram of a connection mode of the base metals of the present application;

FIG. 7 shows a schematic diagram of force analysis of bubbles and slags in an equal-aperture (width) brazing seam;

FIG. 8 shows a scanning electron microscope image of poor gas exhaust in the equal-aperture brazing seam;

FIG. 9 shows a scanning electron microscope image of poor slag discharge in the equal-aperture brazing seam;

FIG. 10 shows a schematic diagram of force analysis of bubbles and slags in a brazing seam of the present application; and

FIG. 11 shows a scanning electron microscope image of the structure of the brazing seam of the present application.

In the figures, 100-first base metal; 110-first welding surface; 200-second base metal; 210-second welding surface; 300-brazing seam; L1-first distance; L2-second distance; 330-bubble; 340-slag.

### DETAILED DESCRIPTION OF EMBODIMENTS

The technical solutions of the present application are further described through the specific embodiments of the present application below in combination with figures, but the present application is not limited to these embodiments.

It should be noted that all directional indications (such as upper, lower, left, right, front, rear . . . ) in the embodiments of the present application are only used to explain the relative positional relationship, movement, etc. between the components in a particular posture (as shown in figures), and if the particular posture changes, the directional indications change accordingly.

### Embodiment I

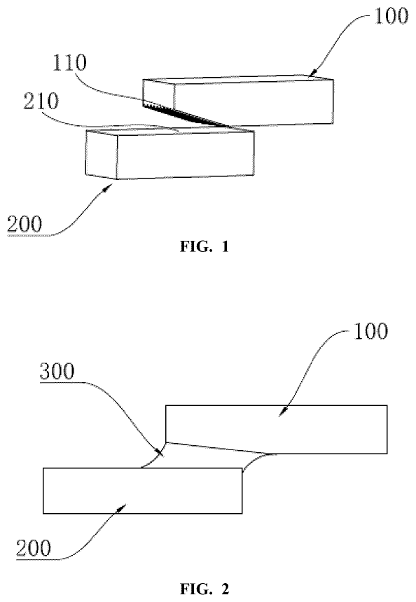

As shown in FIG. 1 to FIG. 11, the present application provides a brazing joint for promoting solder rheology and air overflow, including: a first base metal 100, a second base metal 200, and a brazing seam 300 located between the first base metal 100 and the second base metal 200, wherein the brazing seam 300 is formed by filling a solder in a gap formed by a welding surface of the first base metal 100 and a welding surface of the second base metal 200 and melting it to connect the first base metal 100 and the second base metal 200, wherein the brazing seam 300 is a concave-shaped brazing seam; the gap defines a first distance L1 and a second distance L2, the first distance L1 is located at an edge of the gap, the second distance L2 is located at the edge or inside of the gap, the first distance L1 is greater than the second distance L2, and a curved surface is formed between the location of the first distance L1 and the location of the second distance L2 for transition.

Further, preferably, the curved surface is provided on the first base metal 100 and/or the second base metal 200.

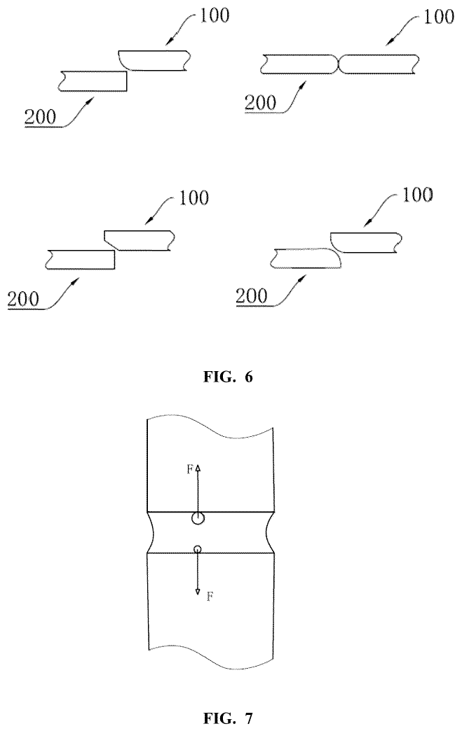

In traditional brazing technology, the effect of slag discharge and gas overflow is not ideal, resulting in a decrease in the brazing rate of the brazing joint, which further affects the welding quality and even affects the use safety of the product. In the present embodiment, a brazing joint for promoting solder rheology and gas overflow is provided, wherein a first distance L1 and a second distance L2 which are not equal to each other are defined in a gap between the first base metal 100 and the second base metal 200, the first distance L1 is located at an edge of one side of the gap, the second distance L2 is located at inside or an edge of the gap, the first distance L1 located at the edge of the first base metal 100 and/or the second base metal 200 is greater than the second distance L2, and a curved surface is provided between the location of the first distance L1 and the location of the second distance L2 for transition, to enable the distance from the inside of the gap to the edge of the gap to increase gradually. The first distance L1 is ensured to be greater than the second distance L2, that is, the distance of the edge of at least one side of the gap is greater than the distance inside the gap, so that during the brazing process, bubbles and slags may be discharged from the location of the second distance L2 to the location of the first distance L1, until being discharged out from the brazing seam. In addition, the provision of the concave-shaped brazing seam further promotes the discharge of bubbles and slags, which greatly improves the efficiency of the slag discharge during the brazing process, and effectively improves the quality of the joint to ensure the product welding quality. Specifically, the connection mode of the first base metal 100 and the second base metal 200 is shown in FIG. 6, the first base metal 100 and the second base metal 200 may be connected by a slope or a curved surface, ensuring that an unequal-aperture gap is formed between the first base metal 100 and the second base metal 200, the gap defines the first distance L1 and the second distance L2, and the first distance L1 at the edge of the gap is greater than the second distance L2, which promotes the discharge of bubbles 330 and slags 340 from the location of the second distance L2 to the location of the first distance L1, until being discharged out of the brazing seam 300.

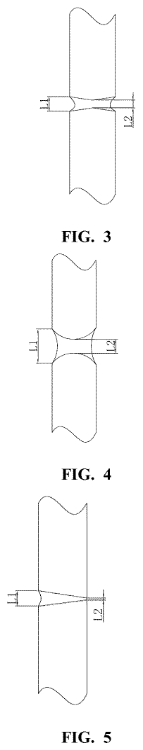

Preferably, as shown in FIG. 3 to FIG. 5, a cross-section shape of the welding surface is arranged as an arc-surface or a slope.

In the present embodiment, the cross-section shape of the welding surface is arranged as an arc-surface or a slope. No matter what the shape is, it is only required to keep the first distance L1 greater than the second distance L2, and make the transition between the second distance L2 and the first distance L1 be a curved surface, to ensure that the bubbles and slags may move along the brazing seam 300 to the location of the first distance L1 during the brazing process, wherein the low-density bubbles are discharged out along the top of the brazing seam 300, and high-density slag are discharged out along the bottom of the brazing seam 300, to improve the welding quality. Specifically, the second distance L2 may be located at the middle of the gap or at the edge of the gap. As shown in FIG. 3 and FIG. 4, when the distances at two sides of the gap are greater than the distance at the middle of the gap, the first distance L1 is located at the edge of the gap, the second distance L2 is located at inside of the gap, that is, it is ensured that the first distance L1 is greater than the second distance L2. As shown in FIG. 5, the cross section of the brazing seam is “V”-shaped, and the two sides of the gap are a large-distance side and a small-distance side respectively, then the first distance L1 is located at the large-distance side, and the second distance L2 may be located at the inside of the gap or the small-distance side, that is, it is ensured that the first distance L1 is greater than the second distance L2.

Preferably, as shown in FIG. 1, the first base metal 100 includes a first welding surface 110, and the second base metal 200 includes a second welding surface 210, wherein the first welding surface 110 and/or the second welding surface 210 are provided with strip-shaped textures, and the strip-shaped textures extend from the location of the first distance L1 to the location of the second distance L2.

In the present embodiment, by providing the strip-shaped textures on the first base metal 100 and/or the second base metal 200, and making the strip-shaped textures extend from the location of the first distance L1 to the location of the second distance L2, the flowing of the solder is promoted during the brazing process, to enable the solder under the molten state to flow in the direction of the strip-shaped textures, to ensure the welding quality. The strip-shaped textures are processed by knurling, the processing technology is simple and the production cost is low.

Preferably, as shown in FIG. 1 to FIG. 11, a material of the first base metal 100 is copper, steel, or cemented carbide; and a material of the second base metal is copper, steel, or cemented carbide.

Further, the solder is a copper-based solder or a silver-based solder.

Further, the solder contains 0.2%-1.5% silicon, or 0.5%-3.5% tin, which controls the solder to form the concave-shaped brazing seam 300 along the gap during a brazing process.

In the present embodiment, by using copper, steel, or cemented carbide as the material of the base metals and adding silicon or tin into the solder to regulate the surface tension of the solder, the surface morphology of the brazing seam may be adjusted to make the surface of the brazing seam smooth, which makes a smooth transition at the interface between the brazing seam 300 and the base metals, to control the solder to form the concave-shaped brazing seam along the gap during the brazing process, which facilitates the discharge of the bubbles 330 and the slags 340, and improves the welding quality.

### Embodiment II

The present application further provides a brazing method for promoting solder rheology and gas overflow, which is used for welding the brazing joint for promoting solder rheology and gas overflow according to Embodiment I. The welding surface of the first base metal 100 and the welding surface of the second base metal 200 are coated with brazing flux, the brazing flux is silver brazing flux or copper brazing flux, the first base metal 100, the solder, and the second base metal 200 are assembled into a to-be-welded brazing joint, and the to-be-welded brazing joint is heated to complete the brazing process, to obtain the brazing joint.

In the present embodiment, a brazing method for promoting solder rheology and gas overflow is provided, wherein the brazing flux is coated on the welding surface of the first base metal 100 and the welding surface of the second base metal 200, the brazing joint is formed by heating and brazing the to-be-welded brazing joint assembled by the first base metal 100, the solder and the second base metal 200, and a concave-shaped brazing seam 300 is formed inside the brazing joint. In addition, the gap formed between the welding surface of the first base metal 100 and the welding surface of the second base metal 200 defines a first distance L1 and a second distance L2, wherein the first distance L1 is located at an edge of the gap, the first distance L1 is greater than the second distance L2, and a curved surface is provided between the location of the first distance L1 and the location of the second distance L2 for transition, so that an unequal-aperture gap is formed between the first welding surface 110 and the second welding surface 210, to control bubbles and slags inside the solder to be discharged along the inside of the gap to the outside of the gap during the brazing process, which greatly improves the overall welding efficiency and the welding quality, to avoid the poor welding caused by an over-low brazing rate which results in poor product quality.

Preferably, vibration is applied to the brazing joint during the brazing process, wherein the vibration has phase-shifted longitudinal waves and transverse waves, to promote the solder to flow in the gap.

In the present embodiment, the vibration is applied to the brazing joint during the brazing process. Specifically, the vibration is applied by an ultrasonic vibrator, the ultrasonic vibrator produces longitudinal vibration during the welding process, and the longitudinal vibration produces standing longitudinal waves, the vibration generates transverse waves with determined vibration nodes, and the transverse waves have phase shift relative to the longitudinal waves, the longitudinal waves may promote the bubbles and the brazing flux residues whose densities are less than that of the liquid solder, to float, and promote the slags with a density greater than that of the liquid solder to sink, and the transverse waves may promote the bubbles, the brazing flux residues, and the slags to move towards a wide gap to be finally discharged out of the brazing seam 300. The generation of the longitudinal waves and the transverse waves further promote the flowing of the solder during the welding process, to enable the solder under the molten state to quickly flow in the gap between the first base metal 100 and the second base metal 200, wherein the flowing of the bubbles is also promoted while promoting the flowing of the solder, accelerating the discharge of the bubbles and the slags, and greatly improving the welding quality.

Preferably, a magnetic field is applied to the brazing joint during the brazing process to promote the flowing of the solder in the gap.

In the present embodiment, the magnetic field is applied to the brazing joint during the brazing process. Specifically, a magnetic field generator is provided. The magnetic field generator includes two groups of coils with the same height, and the two groups of coils are separated by ninety degrees, the two groups of coils are connected to an excitation power supply through a waveform shifter, respectively. The two groups of coils are adjusted to be connected with the synchronous sinusoidal alternating current and the cosine alternating current, respectively, and the phase difference between the sinusoidal alternating current and the cosine alternating current is ninety degrees. When the power is on, a magnetic field parallel to the coil axis is generated in the middle of each of the groups of coils, the magnetic field also changes in sine and cosine with the change of the current. The direction of the magnetic field moves circularly, and the liquid solder has rheology (i.e., flows and deforms) in fluctuation, which greatly accelerates the flow speed of the solder and improves the welding efficiency.

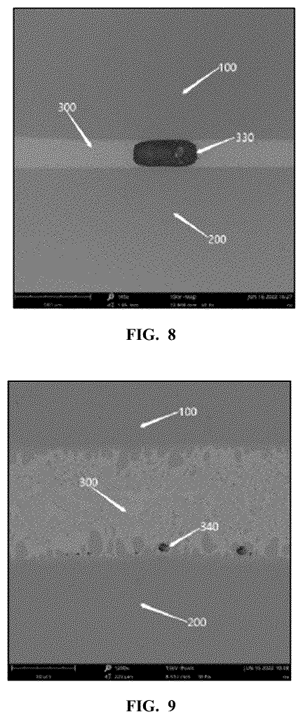

Further, preferably, before brazing, the base metals are required to be pretreated. Specifically, it includes processing the surface shapes of the base metals, removing the slags on the surfaces of the base metals, and processing the strip-shape textures on the welding surfaces of the base metals. Specifically, firstly, the surface shapes of the base metals are processed, so that an unequal-aperture gap is generated between the first base metal 100 and the second base metal 200, and the gap defines the first distance L1 and the second distance L2, the first distance L1 is located at the edge of the gap, and the first distance L1 is greater than the second distance L2, that is, it is ensured that the gap internal distance is at least less than the external distance of one side thereof, so that during the welding process, the slags and bubbles in the solder may move from the inside with a small distance to the outside with a large distance until being completely discharged, which greatly promotes the discharge of the slags and bubbles and improves the welding quality. In the prior art, most of the brazing seams 300 are equal-aperture brazing seams 300, and the force analysis of the bubbles, the brazing flux residues, and the slags is shown in FIG. 7, wherein F represents the upward buoyancy of the bubbles and the downward gravity of the slags. The bubbles and the brazing flux residues with densities less than that of the liquid solder move upward under the action of buoyancy, and after contacting the welding surfaces, may stay on the welding surfaces of the base metals due to the absence of lateral force, isolating the contact between the solder and the base metals, and resulting in a decrease in the brazing rate. Similarly, the slags with a high density may stay at the bottom base metal, isolating the contact between the solder and the base metals, and resulting in a decrease in the brazing rate. The specific object pictures are shown in FIG. 8 and FIG. 9, it may be seen that due to the poor gas exhaust in the equal-aperture brazing seam in FIG. 8, it is easy to form the bubbles 330 in the brazing seam 300. Due to the poor slag discharge in the equal-aperture brazing seam in FIG. 9, the residual slags 340 are formed in the brazing seam 300, which reduces the brazing rate and affects the welding quality.

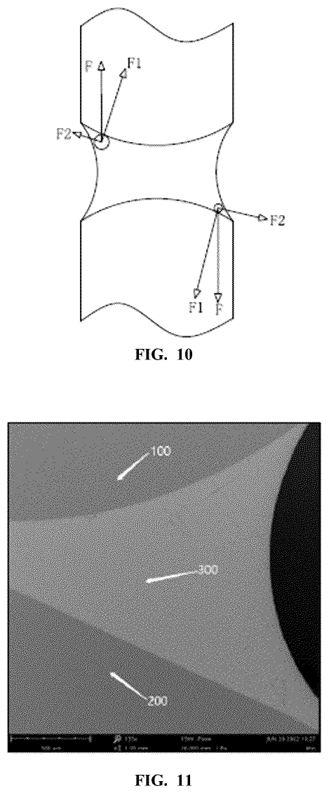

However, an unequal-aperture brazing seam 300 is provided in the present embodiment. The force analysis of the bubbles, the brazing flux residues, and the slags is shown in FIG. 10, wherein F represents the upward buoyancy of the bubbles and the downward gravity of the slags. Under the action of the slope of the gap, F is decomposed into the first lateral force F1 and the second lateral force F2. In the unequal-aperture brazing seam 300, the bubbles and the brazing flux residues whose densities are less than that of the liquid solder, and the slags with a density greater than that of the liquid solder are subjected to the second lateral force F2, making the bubbles, the brazing flux residues, and the slags move along the inside of the gap to the outside of the gap until they are discharged out of the brazing seam 300, which improves the brazing rate of the brazing joint. The specific object picture is shown in FIG. 11, it may be seen that by using the unequal-aperture gap to enable the brazing seam 300 to form the concave-shaped brazing seam 300, the gas and the slags are easier to be discharged, the solder and the base metals are fully metallurgically bonded, and the brazing rate is greatly improved.

Further, preferably, the brazing seam 300 is formed by filling the solder in the gap formed by the welding surface of the first base metal 100 and the welding surface of the second base metal 200 and melting the solder to connect the first base metal 100 and the second base metal 200, the solder contains silicon element or tin element, and the solder is controlled to form a concave-shaped brazing seam 300 along the gap during the brazing process.

In the present embodiment, the solder is preferably BAg30CuZn (silver solder GB/T 10046 2018) induction brazing pure copper, (the butt joint, the first base metal, and the second base metal are all of 30×30×10 mm, the welding surface is a 30×30 mm surface, and in each group, three samples are brazed), the brazing flux is the silver brazing paste (produced by Zhengzhou Research Institute of Mechanical Engineering Co., Ltd.). A mass fraction of 1% of silicon or a mass fraction of 3% of tin is added into BAg30CuZn solder (the solder is added with tin or silicon, and the content of copper is reduced accordingly), the addition of silicon and tin may be able to regulate and control the surface tension of the solder, to control the formation of the concave-shaped curved surface at the end of the brazing seam 300, thus promoting the discharge of the slags and the bubbles and improving the brazing rate. The specific test of brazing rate is shown in the following table:

| | Brazing | | |
|---|---|---|---|
| Number | rate (%) | Brazing seam shape | Remarks |
| Experimental | 94% | Unequal aperture | Containing silicon, |
| example I | | (as shown in FIG. 2) | no vibration, and |
| | | | no magnetic field |
| Experimental | 95% | Unequal aperture | Containing tin, applying |
| example II | | (as shown in FIG. 2) | vibration, and applying |
| | | | a magnetic field |
| Experimental | 96% | Unequal aperture | Containing tin, |
| example III | | (as shown in FIG. 4) | no vibration, and |
| | | | no magnetic field |
| Experimental | 97% | Unequal aperture | Containing silicon, |
| example IV | | (as shown in FIG. 4) | no vibration, and |
| | | | no magnetic field |
| Experimental | 100% | Unequal aperture | Containing tin, applying |
| example V | | (as shown in FIG. 3) | vibration, and applying |
| | | | a magnetic field |
| Experimental | 92% | Unequal aperture | No silicon, no tin, |
| example VI | | (as shown in FIG. 5) | no vibration, and |
| | | | no magnetic field |
| Comparison | 89% | Equal aperture | No silicon, no tin, |
| example I | | | no vibration, and |
| | | | no magnetic field |
| Comparison | 92% | Equal aperture | Containing silicon, |
| example II | | | applying vibration |
| | | | and a magnetic field |
| Comparison | 92% | Equal aperture | Containing tin, applying |
| example III | | | vibration and a magnetic |
| | | | field |
| Comparison | 91% | Equal aperture | Containing tin, |
| example IV | | | no vibration, and |
| | | | no magnetic field |
| Comparison | 91% | Equal aperture | Containing silicon, |
| example V | | | no vibration, and |
| | | | no magnetic field |

From the above data, it may be seen that the addition of the element silicon or tin in the solder, as well as the applying of vibration and a magnetic field during the welding process, may greatly improve the welding quality and improve the brazing rate, wherein when the welding surfaces of two base metals are provided as curved surfaces, and vibration and a magnetic field are applied during the welding process, the brazing rate of the joint may reach 100%, which completely avoids the decrease in the brazing rate caused by the poor discharge of the slags and the bubbles.

### Embodiment III

The present application further provides a device for promoting solder rheology and gas flow, based on the brazing method for promoting solder rheology and gas overflow according to Embodiment II, including a heating mechanism and a vibration unit, wherein transverse waves and longitudinal waves with phase shift are generated by the vibration unit.

In the present embodiment, the device is provided with an ultrasonic vibration unit, the ultrasonic vibration unit generates longitudinal and transverse vibration during the welding process, the longitudinal vibration generates standing longitudinal waves, the vibration generates transverse waves with determined vibration nodes, and the transverse waves have phase shift relative to the longitudinal waves. The longitudinal waves and the transverse waves further promote the flowing of the solder w during the welding process, to enable the solder under the molten state to quickly flow in the gap between the first base metal 100 and the second base metal 200, promoting also the flowing of the bubbles while promoting the flowing of the solder, accelerating the discharge of the bubbles and the slags, and greatly improving the welding quality.

Preferably, the device further includes a magnetic field generator, wherein the magnetic field generated by the magnetic field generator promotes the solder to flow and accelerates the quick discharge of the bubbles and the slags.

In the present embodiment, the magnetic field generator includes two groups of coils with the same height, and the two groups of coils are separated by ninety degrees, the two groups of coils are connected to an excitation power supply through a waveform shifter, respectively. The two groups of coils are adjusted to be connected with the synchronous sinusoidal alternating current and the cosine alternating current, respectively, and the phase difference between the sinusoidal alternating current and the cosine alternating current is ninety degrees. When the power is on, a magnetic field parallel to the coil axis is generated in the middle of each of the groups of coils, the magnetic field also changes in sine and cosine with the change of the current. The direction of the magnetic field moves circularly, and the liquid solder flows and deforms in fluctuation, which greatly accelerates the flow speed of the solder and improves the welding efficiency.

It should be noted that descriptions such as “first”, “second”, “one”, etc. in this application are used for descriptive purposes only and cannot be understood to indicate or imply their importance in relativity or to indicate implicitly the number of technical features indicated. Thus, a feature defined with “first” or “second” may expressly or implicitly include at least one such feature. In the description of this application, “multiple” means at least two, e.g. two, three, etc., unless clearly specified otherwise. The terms “connected”, “fixed′”, etc. should be understood broadly; for example, “'fixed” can be a fixed connection, a detachable connection, or an integrated connection as a whole; it can be a mechanical connection or electrical connection; it can be direct connection or indirect connectioned through an intermediate medium. It can be a connection communication between two components or an interaction relationship between two components, unless otherwise clearly defined. For those people skilled in the art, the specific meaning of the above terms in this application may be understood on a case-by-case basis.

In addition, the technical solutions of the various embodiments of the present application can be combined with each other, but it must be based on the realization of those people skilled in the art. When the combination of technical solutions is contradictory or cannot be realized, it should be considered that the combination of such technical solutions does not exist and is not within the scope of protection claimed in the present application.

The specific embodiments described in the present application are only examples of the spirit of the present application. The people skilled in this field of the present application can make various modifications or supplements to the embodiments described or replace them in a similar way, which however will not deviate from the spirit of the present application or exceed the scope defined by the appended claims.

1. A brazing joint for promoting solder rheology and gas overflow, comprising:
a first base metal, a second base metal, and a brazing seam located between the first base metal and the second base metal, wherein the brazing seam is formed by filling a solder in a gap formed by a welding surface of the first base metal and a welding surface of the second base metal and melting the solder to connect the first base metal and the second base metal, wherein the brazing seam is a concave-shaped brazing seam;
the gap defines a first distance and a second distance, the first distance is located at an edge of the gap, the second distance is located at the edge or an inside of the gap, the first distance is greater than the second distance, and a curved surface is formed between location of the first distance and location of the second distance for transition.

2. The brazing joint for promoting solder rheology and gas overflow according to claim 1, wherein the curved surface is provided on the first base metal and/or the second base metal.

3. The brazing joint for promoting solder rheology and gas overflow according to claim 1, wherein the first base metal comprises a first welding surface, and the second base metal comprises a second welding surface, wherein the first welding surface and/or the second welding surface are provided with strip-shaped textures, and the strip-shaped textures extend from the location of the first distance to the location of the second distance.

4. The brazing joint for promoting solder rheology and gas overflow according to claim 1, wherein a material of the first base metal is copper, Preliminary Amendment steel, or cemented carbide; and a material of the second base metal is copper, steel, or cemented carbide.

5. The brazing joint for promoting solder rheology and gas overflow according to claim 1, wherein the solder is a copper-based solder, or a silver-based solder.

6. The brazing joint for promoting solder rheology and gas overflow according to claim 5, wherein the solder comprises 0.2%-1.5% silicon, or 0.5%-3.5% tin, which controls the solder to form the concave-shaped brazing seam along the gap during a brazing process.

7. A brazing method for promoting solder rheology and gas overflow, which is used for welding the brazing joint for promoting solder rheology and gas overflow according to claim 1, wherein the welding surface of the first base metal, and the welding surface of the second base metal are coated with brazing flux; the first base metal, the solder, and the second base metal are assembled into a to-be-welded brazing joint, and the to-be-welded brazing joint is heated to complete a brazing process, to obtain the brazing joint.

8. The brazing method for promoting solder rheology and gas overflow according to claim 7, wherein vibration is applied to the brazing joint during the brazing process, and the vibration has phase-shifted longitudinal waves and transverse waves, to promote flowing of the solder in the gap.

9. The brazing method for promoting solder rheology and gas overflow according to claim 8, wherein a magnetic field is applied to the brazing joint during the brazing process, to promote the flowing of the solder in the gap.

10. A device for promoting solder rheology and gas overflow, comprising a heating mechanism, wherein the device, based on the brazing method Preliminary Amendment for promoting solder rheology and gas overflow according to claim 7, comprises a vibration unit and/or a magnetic field generator.

11. The brazing method for promoting solder rheology and gas overflow according to claim 7, wherein the curved surface is provided on the first base metal and/or the second base metal.

12. The brazing method for promoting solder rheology and gas overflow according to claim 7, wherein the first base metal comprises a first welding surface, and the second base metal comprises a second welding surface, wherein the first welding surface and/or the second welding surface are provided with strip-shaped textures, and the strip-shaped textures extend from the location of the first distance to the location of the second distance.

13. The brazing method for promoting solder rheology and gas overflow according to claim 7, wherein a material of the first base metal is copper, steel, or cemented carbide; and a material of the second base metal is copper, steel, or cemented carbide.

14. The brazing method for promoting solder rheology and gas overflow according to claim 7, wherein the solder is a copper-based solder, or a silver-based solder.

15. The brazing method for promoting solder rheology and gas overflow according to claim 14, wherein the solder comprises 0.2%-1.5% silicon, or 0.5%-3.5% tin, which controls the solder to form the concave-shaped brazing seam along the gap during a brazing process.
